(19) United States
(12) Patent Application Publication
(10) Pub. No.: US 2025/0042455 A1
(43) Pub. Date: Feb. 6, 2025

(54) HEALTH ASSESSMENT APPARATUS, HEALTH ASSESSMENT METHOD, AND COMPUTER READABLE MEDIUM

(71) Applicant: Mitsubishi Electric Corporation, Tokyo (JP)

(72) Inventors: Tomoharu TAKEUCHI, Tokyo (JP); Masafumi YAMADA, Tokyo (JP)

(73) Assignee: Mitsubishi Electric Corporation, Tokyo (JP)

(21) Appl. No.: 18/921,739

(22) Filed: Oct. 21, 2024

Related U.S. Application Data
(63) Continuation of application No. PCT/JP2022/024306, filed on Jun. 17, 2022.

(51) Int. Cl. B61L 27/57

(52) U.S. Cl. CPC B61L 27/57

(57) ABSTRACT

A health assessment apparatus assesses health of a vehicle composition made up of a plurality of nodes. An instrument assessment unit calculates a health assessment value representing health for a terminal node among the plurality of nodes, the terminal node being a node for which there is no lower node to depend on. A composition assessment unit (303) obtains dependency information in which dependencies between the plurality of nodes are set from a dependency database (332). For an assessment target node, a composition health estimation unit (331) of the composition assessment unit (303) dynamically determines an integration process to integrate a health assessment value of the lower node in accordance with a relationship of magnitude between the health assessment value of the lower node and each of a plurality of thresholds, and calculates a health assessment value (31) of the assessment target node through the dynamically determined integration process.

### CROSS REFERENCE TO RELATED APPLICATION

This application is a Continuation of PCT International Application No. PCT/JP2022/024306, filed on Jun. 17, 2022, which is hereby expressly incorporated by reference into the present application.

### TECHNICAL FIELD

The present disclosure relates to a health assessment apparatus, a health assessment method, and a health assessment program. In particular, it relates to a health assessment system, a health assessment apparatus, a health assessment method, and a health assessment program for assessing health associated with vehicle compositions.

### BACKGROUND ART

In recent years, streamlining and optimization of railway maintenance by means of condition-based maintenance have been implemented. Condition-based maintenance is also referred to as CBM. CBM is an abbreviation for Condition Based Maintenance. For planning of a maintenance schedule, individual health assessment on each component instrument in a vehicle composition is not sufficient; health needs to be assessed for each vehicle composition as a unit of maintenance. However, comprehensive assessment in consideration of the importance of each component instrument has not been achieved, making it difficult to determine an exact timing of maintenance.

Patent Literature 1 discloses a technique to calculate a normal operation rate of the top node using the normal operation rate of each node and its impact value on an upper node in a service system where a connection relationship among multiple nodes consists of a hierarchical structure.

### CITATION LIST

### Patent Literature

Patent Literature 1: JP 2011-180805 A

### SUMMARY OF INVENTION

### Technical Problem

It is conceivable to apply a hierarchical structure representing a relationship between a vehicle composition and multiple component instruments included in the vehicle composition to Patent Literature 1 and to calculate the normal operation rate of the vehicle composition, which is the top node. The technique of Patent Literature 1 calculates the normal operation rate of the top node using the normal operation rate of each node and its impact value on an upper node.

With the technique of Patent Literature 1, however, if health of some nodes deteriorates, deterioration information in health would be rounded in the course of integrating information on health into upper nodes. Thus, it has a challenge that poor conditions of some nodes are obscured when calculating the health of the entire vehicle composition.

The present disclosure dynamically determines an integration process to integrate health assessment values of lower nodes in accordance with the relationship of magnitude between the health assessment value of each of lower nodes of an assessment target node for which health is being assessed and each of multiple thresholds. By thus appropriately reflecting any abnormality or deteriorated conditions of some lower nodes into the health assessment value of the assessment target node, the present disclosure is aimed at in turn appropriately reflecting it into the health assessment value of the vehicle composition as the top node.

### Solution to Problem

A health assessment apparatus according to the present disclosure assesses health of a vehicle composition made up of a plurality of nodes, and includes:
an instrument assessment unit to calculate a health assessment value representing health for a terminal node among the plurality of nodes, the terminal node being a node for which there is no lower node to depend on; and
a composition assessment unit to obtain dependency information, in which dependencies between the plurality of nodes are set with the vehicle composition at top, from a dependency database that stores the dependency information, and for an assessment target node, among the plurality of nodes, that is being assessed and for which there is a lower node to depend on, to dynamically determine an integration process to integrate a health assessment value of the lower node in accordance with a relationship of magnitude between the health assessment value of the lower node and each of a plurality of thresholds, and to calculate a health assessment value of the assessment target node through the dynamically determined integration process.

### Advantageous Effects of Invention

In the health assessment apparatus according to the present disclosure, the composition assessment unit dynamically determines the integration process to integrate the health assessment value for a lower node of the assessment target node in accordance with the relationship of magnitude between the health assessment value of the lower node and each of the multiple thresholds. Thus, the health assessment apparatus according to the present disclosure provides the effect of appropriately reflecting any abnormality or deteriorated conditions of some nodes into the health assessment value of the assessment target node, thereby in turn appropriately reflecting it into the health assessment value of the vehicle composition as the top node.

### BRIEF DESCRIPTION OF DRAWINGS

FIG. 1 illustrates a configuration example of a health assessment system according to Embodiment 1.

FIG. 2 illustrates a detailed configuration example of a composition health estimation unit in a composition assessment unit according to Embodiment 1.

FIG. 3 illustrates a hardware configuration example of the health assessment system according to Embodiment 1.

FIG. 4 is an overall flow diagram of a health assessment process by a health assessment apparatus according to Embodiment 1.

FIG. 5 illustrates a construction example of dependency information stored in a dependency database according to Embodiment 1.

FIG. 6 illustrates a comparative example relative to Embodiment 1, showing an exemplary setting in dependencies, with a vehicle composition 10 at the top.

FIG. 7 is a flow diagram of an instrument health assessment process by an instrument assessment unit according to Embodiment 1.

FIG. 8 is a flow diagram of a composition health assessment process by the composition assessment unit according to Embodiment 1.

FIG. 9 is a flow diagram of processing to calculate a health assessment value for an assessment target node according to Embodiment 1.

FIG. 10 is a flow diagram of a visualization information generation process by a visualization information generation unit according to Embodiment 1.

FIG. 11 illustrates an example of visualization information visualizing health assessment information according to Embodiment 1.

FIG. 12 is a flow diagram of processing to define a dependency database and a physical configuration database according to Embodiment 1.

FIG. 13 is a flow diagram of processing to calculate a health assessment value for the assessment target node according to Embodiment 2.

### DESCRIPTION OF EMBODIMENTS

The present embodiments are described below with reference to the drawings. In the drawings, the same or corresponding portions are denoted with the same reference characters. In the description of embodiments, description on the same or the corresponding portions are omitted or simplified as appropriate. Also, in the drawings below, dimensional relationship between components may differ from the actual relationship. Also, in the description of the embodiments, orientations or positions, such as up, down, left, right, front, back, top, and rear, may be indicated. These indications are denotations for the convenience of description and are not intended to limit the placement, direction, and orientation of a device, an instrument, or a component.

### Embodiment 1

### Description of Configuration

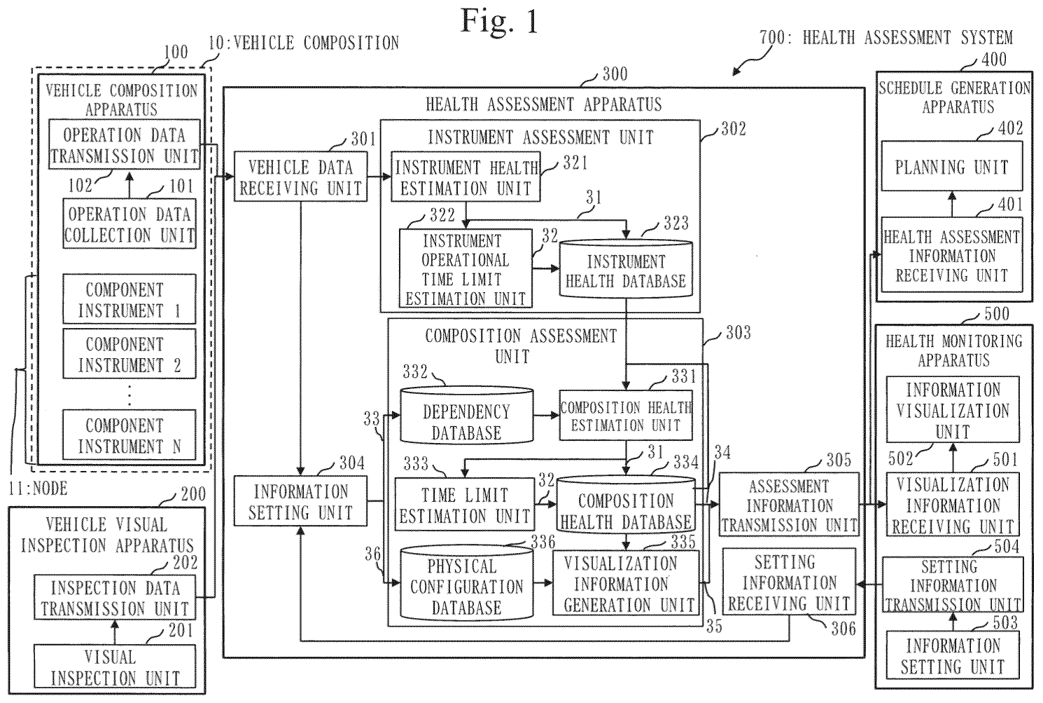

FIG. 1 illustrates a configuration example of a health assessment system 700 according to the present embodiment.

The health assessment system 700 is a system for assessing the health of a vehicle composition 10 made up of multiple nodes 11. The nodes 11 are also referred to as component instruments constituting the vehicle composition 10, or just instruments.

The health assessment system 700 includes a vehicle composition apparatus 100, a vehicle visual inspection apparatus 200, a health assessment apparatus 300, a schedule generation apparatus 400, and a health monitoring apparatus 500.

Functions of the functional elements included in the apparatuses of the health assessment system 700 are outlined below.

The vehicle composition apparatus 100 is an on-vehicle device mounted on the vehicle composition 10 being assessed. The vehicle composition 10 is a railway vehicle composition, for example. The vehicle composition apparatus 100 may be referred to as a railway vehicle composition.

The vehicle visual inspection apparatus 200 inspects external conditions of various portions of the vehicle composition 10 being assessed.

The health assessment apparatus 300 makes health assessment on the vehicle composition 10. The health assessment apparatus 300 is a device that assesses the health of the vehicle composition 10 made up of multiple nodes 11.

The schedule generation apparatus 400 calculates schedules such as a maintenance schedule and an operation schedule using health assessment information 34 for the vehicle composition 10 calculated by the health assessment apparatus 300.

The health monitoring apparatus 500 performs setting or modification of various types of definition information, such as dependency information 33 for the nodes or physical configuration information 36 for the nodes, which are used in health assessment. The health monitoring apparatus 500 also checks and monitors the health assessment information 34 calculated by the health assessment apparatus 300.

In the vehicle composition apparatus 100, the vehicle composition 10 is configured as a collection of N nodes 11. The vehicle composition apparatus 100 includes an operation data collection unit 101 and an operation data transmission unit 102. The operation data collection unit 101 obtains status data during operation from each node as instrument operation data. The operation data transmission unit 102 transmits the instrument operation data to the health assessment apparatus 300.

The vehicle visual inspection apparatus 200 includes a visual inspection unit 201 that inspects the conditions of various portions from the outer appearance of the vehicle composition 10 being assessed, and an inspection data transmission unit 202 that transmits visual inspection data, which is result data from inspection by the visual inspection unit 201, to the health assessment apparatus 300.

The health assessment apparatus 300 includes a vehicle data receiving unit 301, an instrument assessment unit 302, a composition assessment unit 303, an information setting unit 304, an assessment information transmission unit 305, and a setting information receiving unit 306.

The vehicle data receiving unit 301 receives instrument operation data, node dependencies, and physical configuration information transmitted from the vehicle composition apparatus 100. The vehicle data receiving unit 301 also receives visual inspection data transmitted from the vehicle visual inspection apparatus 200.

The instrument assessment unit 302 assesses health for each node of the vehicle composition 10. In particular, the instrument assessment unit 302 assesses health of a terminal node for which there is no lower node on which that node is dependent, among the multiple nodes 11.

The composition assessment unit 303 calculates, for each node 11, a health assessment value 31 by information integration of the health assessment values for its lower nodes. The composition assessment unit 303 then assesses the health of the vehicle composition 10 as a whole using health assessment information 34 including the health assessment values 31 for the respective nodes 11.

The information setting unit 304 generates various types of definition information, such as dependency information 33 for the nodes 11 and physical configuration information 36 for the nodes 11, which are necessary for health assessment on the vehicle composition 10. The information setting unit 304 stores the dependency information 33 in a dependency database 332 and the physical configuration information 36 in a physical configuration database 336.

The assessment information transmission unit 305 transmits the health assessment information 34 calculated by the composition assessment unit 303 to the schedule generation apparatus 400 and the health monitoring apparatus 500.

The setting information receiving unit 306 receives various types of definition information set at the health monitoring apparatus 500.

The instrument assessment unit 302 includes an instrument health estimation unit 321, an instrument operational time limit estimation unit 322, and an instrument health database 323.

The instrument health estimation unit 321 estimates health for a terminal node 11 in the vehicle composition 10 as the health assessment value 31.

The instrument operational time limit estimation unit 322 estimates an operational time limit 32 of that node from the health assessment value 31.

The instrument health database 323 stores the estimated health assessment value 31 and operational time limit 32.

The composition assessment unit 303 includes a composition health estimation unit 331, the dependency database 332, a time limit estimation unit 333, a composition health database 334, a visualization information generation unit 335, and the physical configuration database 336.

The composition health estimation unit 331 performs, for each of the nodes 11 in the vehicle composition 10, information integration of the health assessment value of each lower node on which that node is dependent. The composition health estimation unit 331 calculates the health assessment value 31 at a node 11 in the vehicle composition 10 in accordance with the relationship of magnitude between the health assessment value of the lower node of that node 11 and each of multiple thresholds. In doing so, the composition health estimation unit 331 dynamically determines an approach to an integration process to integrate the health assessment value for the lower node in accordance with the relationship of magnitude between the health assessment value of the lower node and each of multiple thresholds.

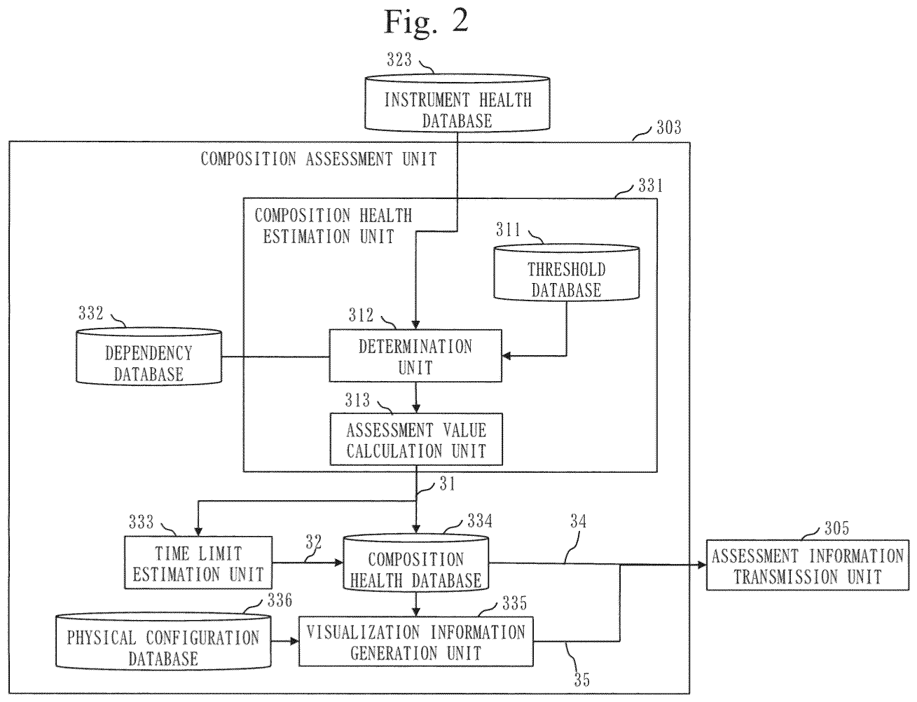

FIG. 2 illustrates a detailed configuration example of the composition health estimation unit 331 in the composition assessment unit 303 according to the present embodiment.

The composition health estimation unit 331 includes a threshold database 311, a determination unit 312, and an assessment value calculation unit 313.

The threshold database 311 stores multiple thresholds for determining the relationship of magnitude with the health assessment values for lower nodes. For example, a first threshold th1 and a second threshold th2 are stored in the threshold database 311.

The functions of the determination unit 312 and the assessment value calculation unit 313 will be discussed later.

The dependency database 332 stores dependency information 33 for nodes 11 required for estimation of health on the vehicle composition 10.

The time limit estimation unit 333 estimates the operational time limit 32 of the vehicle composition 10 from the health assessment value 31 for the vehicle composition 10.

The composition health database 334 stores the estimated health assessment value 31 of the vehicle composition 10 and operational time limit 32 of the vehicle composition 10.

Information including the health assessment value 31 and the operational time limit 32 represents the health assessment information 34.

The visualization information generation unit 335 generates visualization information 35 for visualizing the health assessment value 31 of the vehicle composition 10 and the operational time limit 32 of the vehicle composition 10.

The physical configuration database 336 stores physical configuration information 36 for nodes, namely instruments, necessary for generation of the visualization information 35.

The schedule generation apparatus 400 includes a health assessment information receiving unit 401 that receives the health assessment information 34 for the vehicle composition 10 calculated by the health assessment apparatus 300, and a planning unit 402 that plans a maintenance schedule or an operation schedule for the vehicle composition 10 based on the received health assessment information 34.

The health monitoring apparatus 500 includes a visualization information receiving unit 501, an information visualization unit 502, an information setting unit 503, and a setting information transmission unit 504.

The visualization information receiving unit 501 receives the visualization information 35 visualizing the health assessment information 34 for the vehicle composition 10 calculated by the health assessment apparatus 300.

The information visualization unit 502 visualizes the received health assessment information 34.

The information setting unit 503 performs setting of various types of definition information, such as the dependency information 33 for the nodes or the physical configuration information 36 for the nodes, which are used in health assessment.

The setting information transmission unit 504 transmits the various types of definition information that have been set, such as the dependency information 33 for the nodes or the physical configuration information 36 for the nodes, to the health assessment apparatus 300.

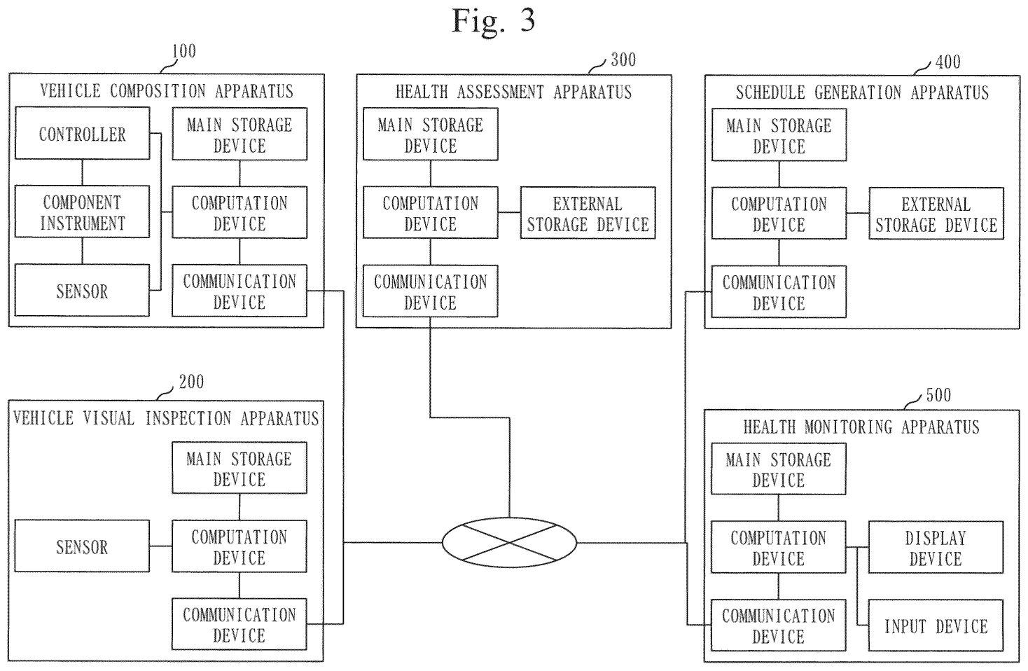

FIG. 3 illustrates a hardware configuration example of the health assessment system 700 according to the present embodiment.

The hardware configuration of the health assessment system 700 includes the vehicle composition apparatus 100, the vehicle visual inspection apparatus 200, the health assessment apparatus 300, the schedule generation apparatus 400, and the health monitoring apparatus 500. The apparatuses in the health assessment system 700 communicate with each other over a network.

The health assessment apparatus 300 and the schedule generation apparatus 400 may be on-premise servers or may be servers configured on cloud.

The vehicle composition apparatus 100 includes the nodes constituting the vehicle composition being assessed, a controller for controlling the operations of the nodes, and sensors for sensing the operational situations of the nodes. The vehicle composition apparatus 100 also includes a computation device that generates instrument operation data to be transmitted to the health assessment apparatus, and a main storage device that temporarily stores information on intermediate data from generation operation of instrument operation data or information for generated instrument operation data. The vehicle composition apparatus 100 further includes a communication device that transmits the generated instrument operation data to the health assessment apparatus.

The vehicle visual inspection apparatus 200 includes sensors for measuring the conditions of various portions from the outer appearance of the vehicle composition. The vehicle visual inspection apparatus 200 also includes a computation device that generates visual inspection data to be transmitted to the health assessment apparatus, and a main storage device that temporarily stores intermediate data from generation operation of visual inspection data or generated visual inspection data. The vehicle visual inspection apparatus 200 further includes a communication device that transmits the generated visual inspection data to the health assessment apparatus.

The health assessment apparatus 300 includes a computation device that performs various types of processing for health assessment on nodes, health assessment on the vehicle composition, generation of visualization information on vehicle composition health, and setting of various types of information. The health assessment apparatus 300 also includes a main storage device that temporarily stores information including various types of intermediate data or generated node health assessment information from the computation device, health assessment information for the vehicle composition, and visualization information. The health assessment apparatus 300 also includes an external storage device that stores generated health assessment information for the nodes, health assessment information for the vehicle composition, dependency information for the nodes, and physical configuration information for the nodes. The health assessment apparatus 300 further includes a communication device that receives instrument operation data, visual inspection data, and various types of setting information data on node dependencies or node physical configuration and transmits health assessment information for the vehicle composition.

The schedule generation apparatus 400 includes a computation device that generates a maintenance schedule or an operation schedule for the vehicle composition from the received health assessment information for the vehicle composition, and a main storage device that temporarily stores intermediate data from generation operation of a maintenance schedule or an operation schedule. The schedule generation apparatus 400 also includes an external storage device that stores the generated maintenance schedule information data or operation schedule information data, and a communication device that receives health assessment information for the vehicle composition.

The health monitoring apparatus 500 includes a computation device that performs visualization processing on the received health assessment information for the vehicle composition for visualization and generation processing of various types of definition information such as node dependencies or node physical configuration. The health monitoring apparatus 500 also includes a main storage device that temporarily stores intermediate data from computations. The health monitoring apparatus 500 also includes a communication device that receives visualization information data related to vehicle composition health assessment and transmits various types of definition information such as node dependencies or node physical configuration. The health monitoring apparatus 500 further includes a display device for displaying visualization information for health assessment on the vehicle composition and an input device for inputting various types of definition information such as node dependencies or node physical configuration.

The apparatuses including the vehicle composition apparatus 100, the vehicle visual inspection apparatus 200, the health assessment apparatus 300, the schedule generation apparatus 400, and the health monitoring apparatus 500 may be called each apparatus of the health assessment system 700.

Each apparatus of the health assessment system 700 is a computer.

The computation device, main storage device, external storage device, input interface, output interface, and communication device included in each apparatus of the health assessment system 700 are described below. The input interface is connected to the input device. The output interface is connected to the display device.

Each apparatus of the health assessment system 700, which is a computer, includes a computation device and other pieces of hardware such as the main storage device, the external storage device, the input interface, the output interface, and the communication device. The computation device is also called a processor. The main storage device is also called memory. The computation device is connected to the other pieces of hardware via signal lines and controls these other pieces of hardware.

The vehicle composition apparatus 100 includes the operation data collection unit 101 and the operation data transmission unit 102 as functional elements.

The vehicle visual inspection apparatus 200 includes the visual inspection unit 201 and the inspection data transmission unit 202 as functional elements.

The health assessment apparatus 300 includes the vehicle data receiving unit 301, the instrument assessment unit 302, the composition assessment unit 303, the information setting unit 304, the assessment information transmission unit 305, and the setting information receiving unit 306 as functional elements.

The schedule generation apparatus 400 includes the health assessment information receiving unit 401 and the planning unit 402 as functional elements.

The health monitoring apparatus 500 includes the visualization information receiving unit 501, the information visualization unit 502, the information setting unit 503, and the setting information transmission unit 504 as functional elements.

Although the hardware will be described below primarily taking the health assessment apparatus 300 as an example, the description below is also applicable to the other apparatuses.

For example, the functional elements of the computer are implemented in software.

The computation device is a device that executes a health assessment program. For example, for the health assessment apparatus 300, the health assessment program is a program that implements the functions of the vehicle data receiving unit 301, the instrument assessment unit 302, the composition assessment unit 303, the information setting unit 304, the assessment information transmission unit 305, and the setting information receiving unit 306.

The computation device is an IC that performs arithmetic processing. Specific examples of a computation device include a CPU, a DSP, and a GPU. IC is an abbreviation for Integrated Circuit. CPU is an abbreviation for Central Processing Unit. DSP is an abbreviation for Digital Signal Processor. GPU is an abbreviation for Graphics Processing Unit.

The main storage device is a storage device that temporarily stores data. Specific examples of a main storage device include SRAM or DRAM. SRAM is an abbreviation for Static Random Access Memory. DRAM is an abbreviation for Dynamic Random Access Memory.

The external storage device is a storage device that archives data. Specific examples of an external storage device include an HDD. The external storage device may also be a portable storage medium such as an SD (registered trademark) memory card, a CF, a NAND flash, a flexible disk, an optical disk, a compact disk, a Blu-ray (registered trademark) disk, and a DVD. Here, HDD is an abbreviation for Hard Disk Drive. SD (registered trademark) is an abbreviation for Secure Digital. CF is an abbreviation for CompactFlash (registered trademark). DVD is an abbreviation for Digital Versatile Disk.

The input interface is a port which is connected to an input device such as a mouse, a keyboard, or a touch panel. The input interface is specifically a USB terminal. The input interface may also be a port which is connected to a LAN. USB is an abbreviation for Universal Serial Bus. LAN is an abbreviation for Local Area Network.

The output interface is a port to which a cable of a display device, such as a display, is connected. The output interface is specifically a USB terminal or an HDMI (registered trademark) terminal. The display is specifically an LCD. The output interface is also called an indicator interface. HDMI (registered trademark) is an abbreviation for High Definition Multimedia Interface. LCD is an abbreviation for Liquid Crystal Display.

The communication device has a receiver and a transmitter. The communication device is connected to a communication network, such as an LAN, the Internet, or a telephone network. The communication device is specifically a communication chip or a NIC. NIC is an abbreviation for Network Interface Card.

The health assessment program is executed in each apparatus of the health assessment system 700. The health assessment program is loaded into the computation device and executed by the computation device. The main storage device also stores an OS in addition to the health assessment program. OS is an abbreviation for Operating System. The computation device executes the health assessment program while running the OS. The health assessment program and the OS may also be stored in an external storage device. The health assessment program and the OS stored in the external storage device are loaded into the main storage device and executed by the computation device. Part or all of the health assessment program may be incorporated into the OS.

The health assessment apparatus 300 may include multiple processors to replace the computation device. These multiple processors share the execution of the health assessment program. Each processor is a device that executes the health assessment program, like the computation device.

Data, information, signal values, and variable values that are utilized, processed, or output by the health assessment program are stored in the main storage device, the external storage device, or a register or cache memory in the computation device.

For example, for the health assessment apparatus 300, the “unit” of the vehicle data receiving unit 301, the instrument assessment unit 302, the composition assessment unit 303, the information setting unit 304, the assessment information transmission unit 305, and the setting information receiving unit 306 may also be read as “circuit”, “process”, “procedure”, “processing”, or “circuitry”. The health assessment program causes a computer to execute a vehicle data reception process, an instrument assessment process, a composition assessment process, an information setting process, an assessment information transmission process, and a setting information reception process. The “process” of the vehicle data reception process, the instrument assessment process, the composition assessment process, the information setting process, the assessment information transmission process, and the setting information reception process may be read as “program”, “program product”, “a computer-readable storage medium having a program stored thereon”, or “a computer-readable recording medium having a program recorded thereon”. The health assessment method is a method that is performed by the execution of the health assessment program by each apparatus of the health assessment system 700.

The health assessment program may be provided by being stored in a computer-readable recording medium. The health assessment program may also be provided as a program product.

### Description of Operation

Next, the operation of the health assessment system 700 according to the present embodiment is described. An operational procedure of the health assessment system 700 corresponds to the health assessment method. A program for implementing the operation of the health assessment system 700 corresponds to the health assessment program that causes a computer to execute the health assessment process. The operation of the health assessment system 700 refers to the operations of each apparatus of the health assessment system 700.

In the description, a node 11 being assessed for which the health assessment value 31 is calculated, namely the assessment target instrument, will be referred to as an assessment target node 20.

The health assessment apparatus 300 is a device that assesses the health of the vehicle composition 10 made up of multiple nodes 11.

### <Health Assessment Process>

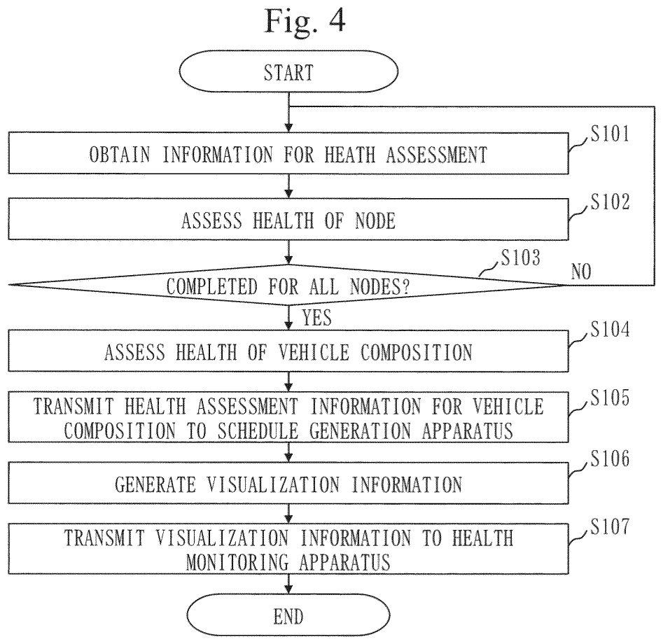

FIG. 4 is an overall flow diagram of the health assessment process by the health assessment apparatus 300 according to the present embodiment.

The health assessment process is executed at the health assessment apparatus 300. The health assessment process may be executed at a regular timing, for example, daily or weekly, or may be executed at a desired timing.

In step S101, the vehicle data receiving unit 301 obtains instrument operation data or visual inspection data corresponding to each of the nodes constituting the vehicle composition as information for assessing instrument health.

In step S102, the instrument assessment unit 302 and the composition assessment unit 303 assess the health of the individual nodes.

The instrument assessment unit 302 calculates health assessment values and operational time limits for terminal nodes for which there is no node on which those nodes are dependent, among the multiple nodes. A node on which a node in question is dependent is called a lower node.

The composition assessment unit 303 calculates health assessment values and operational time limits for the nodes other than the terminal nodes.

The composition assessment unit 303 obtains the dependency information 33 from the dependency database 332. For the assessment target node 20 from the multiple nodes, the composition assessment unit 303 uses the dependency information 33 to dynamically determine the integration process to integrate the health assessment value for a lower node of the assessment target node 20 in accordance with the relationship of magnitude between the health assessment value of the lower node and each of multiple thresholds. The composition assessment unit 303 then uses the dynamically determined integration process to perform information integration of the health assessment values of the lower nodes, thus calculating the health assessment value of the assessment target node 20.

The assessment target node 20 is a node from the multiple nodes which is being assessed and for which there is a lower node to depend on.

In step S103, the composition assessment unit 303 checks whether assessment on all of the nodes in the vehicle composition is completed. If it is not completed, processing returns to step S101 to repeat health assessment on the remaining nodes. If assessment is completed, processing proceeds to step S104.

In step S104, the composition assessment unit 303 assesses health for the vehicle composition and generates health assessment information including the health assessment value and the operational time limit for the vehicle composition.

In step S105, the composition assessment unit 303 transmits the health assessment information for the vehicle composition to the schedule generation apparatus 400 via the assessment information transmission unit 305.

Furthermore, in step S106, the composition assessment unit 303 generates visualization information for visualizing the health assessment information for the vehicle composition.

Finally, in step S107, the composition assessment unit 303 transmits the visualization information to the health monitoring apparatus 500.

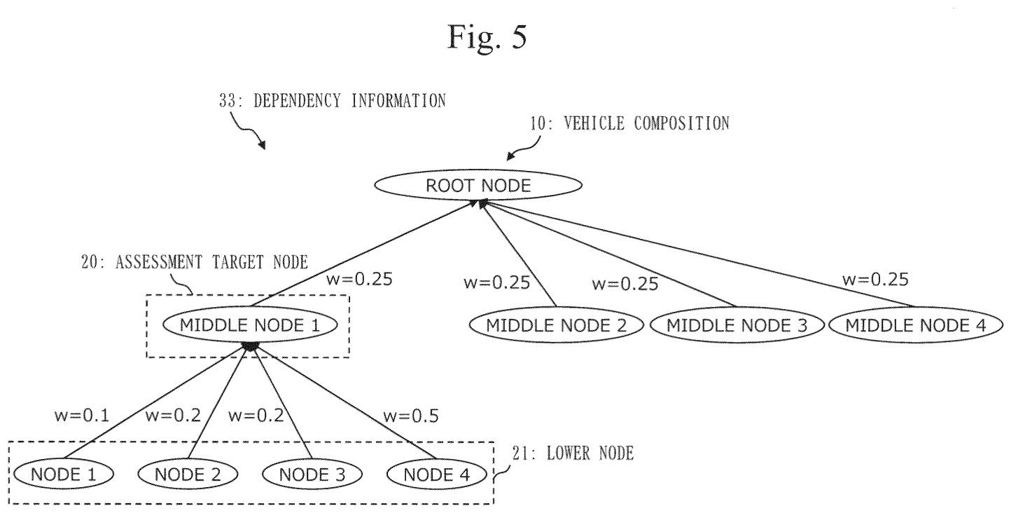

FIG. 5 illustrates a construction example of the dependency information 33 stored in the dependency database 332 according to the present embodiment.

The dependency database 332 stores dependency information 33 in which dependencies between the multiple nodes are set with the vehicle composition 10 at the top. In the dependency database 332, a significance that represents the strength of dependency is set for the dependency information 33.

In the dependency database 332, dependencies are defined by directed graphs (arrows) and the significances of dependencies are associated with the directed graphs.

With the dependency information 33 of FIG. 5, functional dependencies between the vehicle composition 10 as the root node, middle nodes 1, 2, 3, 4 on which the root node is dependent, and nodes 1, 2, 3, 4 on which the middle node 1 is dependent are defined by a directed graph network.

For example, the root node is the vehicle composition 10. Each of the middle nodes 1, 2, 3, 4 is a vehicle on which the vehicle composition 10 is functionally dependent. Each of the nodes 1, 2, 3, 4 is an instrument which is mounted on a vehicle and on which the vehicle is functionally dependent, such as a SIV or a storage battery.

In the following description, the vehicle composition 10 and the nodes that are associated with the vehicle composition may be called all the nodes in the vehicle composition. All the nodes in the vehicle composition including the vehicle composition 10 itself include the vehicle composition 10, middle nodes such as vehicles, and terminal nodes such as SIVs and storage batteries.

A terminal node is a node for which there is no node to depend on, that is, a node for which a directed graph toward that node is not present.

In FIG. 5, the health of the root node depends on the health condition of each of middle nodes 1, 2, 3, 4. The health of middle node 1 depends on the health condition of each of nodes 1, 2, 3, 4.

In FIG. 5, w denotes significance. For example, significance w=0.5 for node 4. The significance w has been established such that for all the dependencies toward a certain node, the sum of the respective significances is 1.

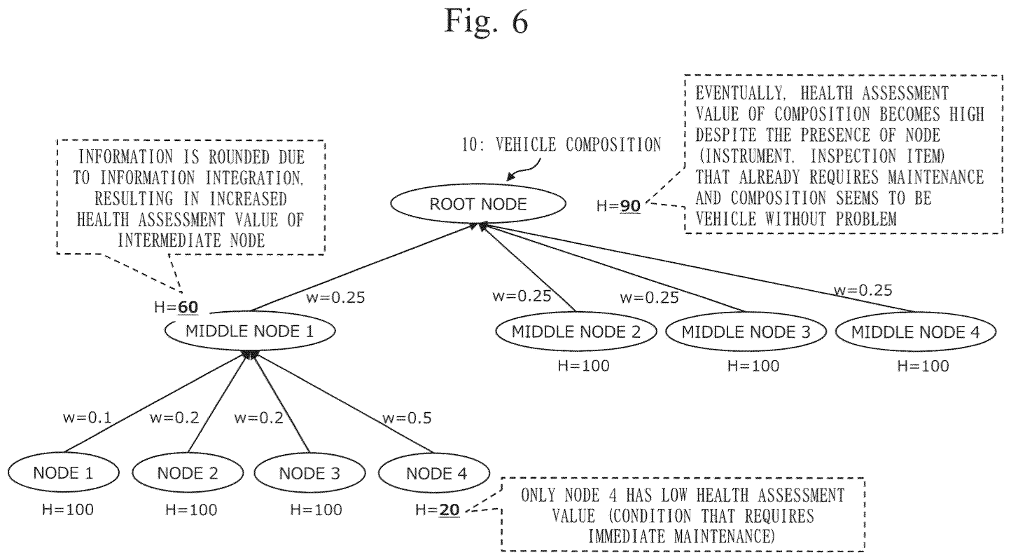

FIG. 6 illustrates a comparative example relative to the present embodiment, showing an exemplary setting in dependencies, with the vehicle composition 10 at the top.

In the comparative example of FIG. 6, the dependencies between the multiple nodes, the significance w of each node, and a calculated health assessment value H have been set.

For example, a health assessment value H of 100 represents the healthiest condition and 0 represents the most abnormal, that is, the riskiest.

In the comparative example, only node 4 has a low health assessment value of 20. However, when significances and health assessment values are simply weighted and added as in the comparative example, the health assessment value for middle node 1 is 60. This way, information is rounded due to information integration, resulting in an increased health assessment value of the intermediate node. Eventually, the health assessment value of the composition becomes high despite the presence of a node (an instrument, an inspection item) that already requires maintenance and the composition seems to be a vehicle without problem.

### <<Instrument Health Assessment Process>>

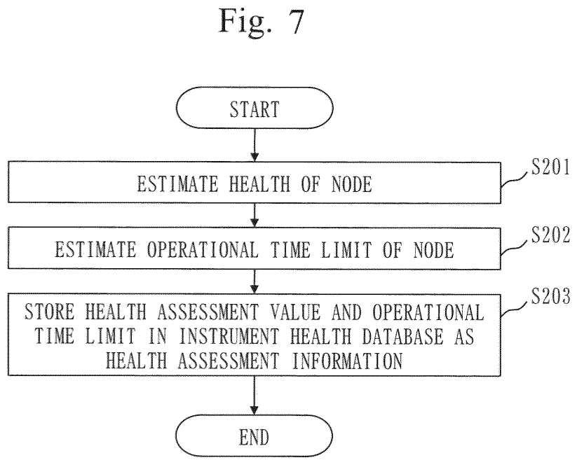

FIG. 7 is a flow diagram of an instrument health assessment process by the instrument assessment unit 302 according to the present embodiment.

The instrument health assessment process is executed at the instrument assessment unit 302 of the health assessment apparatus 300. The instrument health assessment process represents a detailed flow of part of step S102 in the overall flow diagram of FIG. 4.

The instrument health assessment process is processing to perform health assessment on the terminal nodes in the vehicle composition being assessed. In the example of FIG. 5, node 1, node 2, node 3, and node 4 are the terminal nodes.

In step S201, the instrument health estimation unit 321 estimates the health of a terminal node constituting the vehicle composition as a health assessment value on the basis of the instrument operation data or visual inspection data corresponding to that terminal node.

Next, in step S202, the instrument operational time limit estimation unit 322 calculates the operational time limit of the terminal node based on the health assessment value for the terminal node.

In step S203, information on the health assessment value and information on the operational time limit are stored in the instrument health database.

Here, a health assessment value representing the health of a node is residual life information indicating the number of remaining days for which the node can operate without problems such as abnormality or failure, for example. Alternatively, a health assessment value is deterioration level information that numerically indicates how much condition change the node has goes through from the present to the future, that is, how much it will have deteriorated, with respect to a condition that guarantees health, such as a mint condition or immediately following a maintenance. A health assessment value is either or both indicators of residual life information and deterioration level information.

The estimation of health by the instrument health estimation unit 321 in step S201 and the estimation of the operational time limit of the node by the instrument operational time limit estimation unit 322 in step S202 may employ any way of estimation. For example, it may be an estimation method using machine learning or may be an estimation method based on statistical analysis.

### <<Composition Health Assessment Process>>

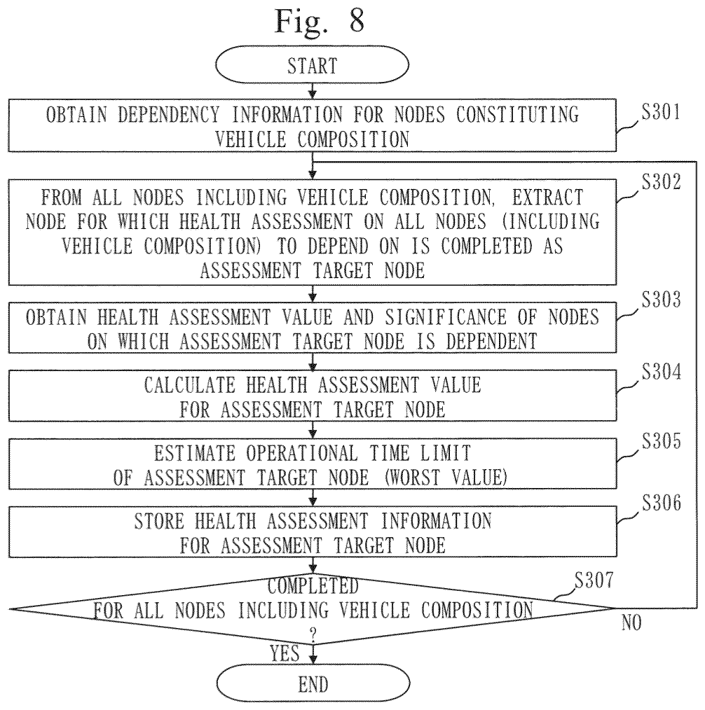

FIG. 8 is a flow diagram of a composition health assessment process by the composition assessment unit 303 according to the present embodiment.

The composition health assessment process is processing for health assessment on the vehicle composition executed at the composition assessment unit 303. The composition health assessment process represents a detailed flow of part of step S102 and step S104 in the overall flow diagram of FIG. 4.

In the example of FIG. 5, health assessments on the terminal nodes for which there is no lower node to depend on, such as node 1, node 2, node 3, and node 4, are already completed. However, health assessment on the middle node 1, which has lower nodes to depend on, is not completed. The composition health assessment process is processing to perform health assessment on such middle nodes and health assessment on the vehicle composition.

In step S301, the composition health estimation unit 331 obtains the dependency information 33 stored in the dependency database 332 for the nodes constituting the vehicle composition 10 being assessed.

In step S302, the composition health estimation unit 331 extracts a node for which health assessment on all the lower nodes on which that node is dependent is completed from among the all the nodes in the vehicle composition, including the vehicle composition itself, and sets the node as the assessment target node 20 for which health is to be assessed.

For the assessment target node 20, there are nodes on which that assessment target node is dependent. That is, for the assessment target node 20, a directed graph toward that assessment target node is present.

A node on which the assessment target node 20 is dependent is referred to as a lower node 21 of the assessment target node.

The composition assessment unit 303 takes a node for which there are nodes to depend on among the multiple nodes as the assessment target node 20 in sequence, and calculates the health assessment value for the assessment target node 20. Finally, when calculation of health assessment values is completed for all the nodes on which the vehicle composition 10 is dependent, the composition assessment unit 303 then calculates the health assessment value for the vehicle composition 10.

Specifically, the composition assessment unit 303 repeats the processing from step S302 to step S307.

In FIG. 5, take the middle node 1 as the assessment target node 20, for example. The lower nodes 21 on which the middle node 1 is dependent are node 1, node 2, node 3, and node 4. When the health assessment is completed for all of node 1, node 2, node 3, and node 4, the health assessment on the middle node 1 is possible.

### <Obtaining Health Assessment Value and Significance for the Lower Nodes 21: Step S303>

In step S303, the composition health estimation unit 331 obtains the health assessment values and operational time limits of the lower nodes 21 on which the assessment target node 20 is dependent. The composition health estimation unit 331 also obtains the significance of the dependency between the assessment target node 20 and each lower node 21.

The composition health estimation unit 331 obtains health assessment information including the health assessment value and operational time limit of the lower node 21 from the instrument health database 323 or the composition health database 334.

If the lower node 21 is a terminal node, the health assessment information is obtained from the instrument health database 323. If the lower node 21 is an intermediate element node, such as a vehicle or a power source, the health assessment information is obtained from the composition health database 334.

In the composition health database 334, health assessment information including health assessment values and operational time limits are stored for intermediate element nodes for which they were already calculated in the processing from step S302 to step S307.

The composition health estimation unit 331 obtains the significance of dependency between the assessment target node 20 and the lower node 21 from the dependency information 33. The significance represents a weight in dependency.

In the specific example of FIG. 5, for nodes 1, 2, 3, 4 as the lower nodes 21 of the middle node 1, the health assessment values, the operational time limits, and the significances of dependency are obtained.

### <Calculating Health Assessment Value for Assessment Target Node 20: Step S304>

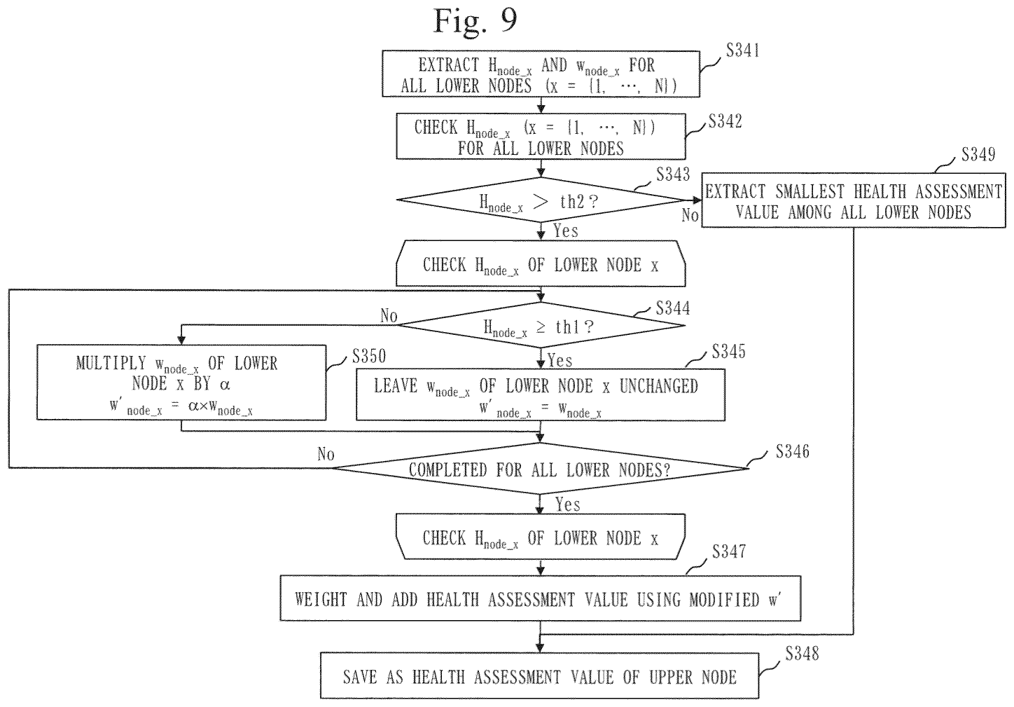

FIG. 9 is a flow diagram of the integration process to calculate the health assessment value for the assessment target node 20 according to the present embodiment. The flow diagram of FIG. 9 represents a detailed flow of step S304.

An overview of the integration process to calculate the health assessment value for the assessment target node 20 in step S304 is described first.

For the assessment target node 20, the composition health estimation unit 331 dynamically determines the integration process to integrate the health assessment value for a lower node in accordance with the relationship of magnitude between the health assessment value of the lower node 21 and each of multiple thresholds. The composition health estimation unit 331 then calculates the health assessment value for the assessment target node 20 through the dynamically determined integration process.

Specifically, the integration process is dynamically determined by the composition health estimation unit 331 in accordance with the relationship of magnitude between the health assessment value of the lower node 21 and each of the first threshold th1 and the second threshold th2 stored in the threshold database 311.

Specifically, this is done in the following manner.

As a precondition for the description of the processing, assume that a health assessment value Hp for the assessment target node 20 is to be calculated. The assessment target node 20 has N lower nodes (x={1, . . . , N}). N is assumed to be an integer equal to or greater than 2. To a lower node x, health assessment value H_{node_x} and significance w_{node_x} correspond.

In step S341, the determination unit 312 of the composition health estimation unit 331 obtains the health assessment value H_{node_x} and the significance w_{node_x} for all of the lower nodes (x={1, . . . , N}). Here, the significance of a lower node obtained from the dependency information 33 is referred to as corresponding significance.

In the example of FIG. 5, given that the middle node 1 is the assessment target node 20, the health assessment value H and the corresponding significance w for each of nodes 1, 2, 3, 4 are obtained.

In steps S342 and S343, the determination unit 312 determines whether or not there is a lower node among the multiple lower nodes that has a health assessment value equal to or smaller than the second threshold th2, which is smallest of the multiple thresholds.

Specifically, the determination unit 312 determines whether H_{node_x}>th2 or not for the health assessment value H_{node_x} (x={1, . . . , N}) for all of the lower nodes.

If all of the health assessment values for the lower nodes are greater than the second threshold th2, processing proceeds to step S344.

On the other hand, if any of health assessment values of the lower nodes is equal to or smaller than the second threshold th2, processing proceeds to step S349.

Here, it is determined whether all of the health assessment values for the lower nodes are greater than the second threshold th2 or not, that is, whether there is any lower node that has a health assessment value equal to or smaller than the second threshold th2 or not. However, it may also be determined whether all of the health assessment values for the lower nodes are equal to or greater than the second threshold th2 or not, that is, whether there is any lower node that has a health assessment value smaller than the second threshold th2 or not. In the following description, “equal to or greater than” or “equal to or smaller than” may be similarly replaced with “greater than” or “smaller than” as long as they are consistent.

The processing in step S349 is processing for a case where there is a lower node having a health assessment value equal to or smaller than the second threshold th2. If there is a lower node having a health assessment value equal to or smaller than the second threshold th2 among the multiple lower nodes, the assessment value calculation unit 313 performs the integration process to integrate the health assessment values for the lower nodes as follows.

In step S349, the assessment value calculation unit 313 performs, as the integration process, an integration process to set the smallest health assessment value of the respective health assessment values of the multiple lower nodes to be the health assessment value for the assessment target node 20. Processing then proceeds to step S348.

The processing in step S344 to step S346 is processing for a case where all of the health assessment values for the lower nodes are greater than the second threshold th2, that is, a case where there is no lower node that has a health assessment value equal to or smaller than the second threshold th2.

The processing in step S344 to step S346 calculates an integrated significance w′ dependent on the relationship of magnitude between the health assessment value and the first threshold th1 for each of all the lower nodes.

Then, in step S347, for each of all the lower nodes, its health assessment value is multiplied by the integrated significance w′ and the resulting values are added, thus calculating the health assessment value for the assessment target node 20.

An overview of the processing in step S344 to step S347 is as follows.

If there is no lower node that has a health assessment value equal to or smaller than the second threshold th2 among the multiple lower nodes, the assessment value calculation unit 313 obtains the significance corresponding to each lower node from the dependency information as the corresponding significance w for each one of the multiple lower nodes. The assessment value calculation unit 313 calculates the integrated significance w′ by multiplying the corresponding significance w by a weighting factor α which is defined in accordance with the relationship of magnitude between the health assessment value of each lower node and each of the multiple thresholds. The assessment value calculation unit 313 multiples the health assessment value of each lower node by the integrated significance w′ and adds the values resulting from the multiplications. The assessment value calculation unit 313 performs processing to set the value resulting from the addition as the health assessment value for the assessment target node 20. The assessment value calculation unit 313 dynamically determines the processing above as the integration process to integrate the health assessment values for the lower nodes, and calculates the health assessment value for the assessment target node 20 through the dynamically determined integration process.

Specifically, this is done in the following manner.

The assessment value calculation unit 313 performs the processing for one lower node out of all the lower nodes as the multiple lower nodes.

In step S344, the assessment value calculation unit 313 determines whether the lower node undergoing processing has a health assessment value equal to or greater than the first threshold th1, which is greatest of the multiple thresholds. That is, the assessment value calculation unit 313 determines whether H_{node_x}≥th1 or not for the health assessment value H_{node_x} of the lower node_x.

If the lower node has a health assessment value equal to or greater than the first threshold th1, the processing proceeds to step S345.

If the lower node does not have a health assessment value equal to or greater than the first threshold th1, the processing proceeds to step S350.

In step S345, for a lower node that has a health assessment value equal to or greater than the first threshold th1, the assessment value calculation unit 313 obtains its corresponding significance w as the integrated significance w′ without modification. That is, the assessment value calculation unit 313 leaves the corresponding significance w_{node_x} of the lower node_x unchanged, w′_{node_x}=w_{node_x}.

In step S350, for a lower node that has a health assessment value smaller than the first threshold th1, the assessment value calculation unit 313 calculates the product of the corresponding significance w and the weighting factor α as the integrated significance w′. That is, the assessment value calculation unit 313 multiples the corresponding significance w_{node_x} of the lower node_x by α, that is, w′_{node_x}=α×w_{node_x}. Multiplication by the weighting factor α is constant multiple, such as 2 times, 3 times, or 5 times. α may be established in any manner according to conditions such as the significance, risk level, or cost of each node in the vehicle composition.

This processing increases significance for lower nodes that have relatively small health assessment values, thus allowing deterioration of some lower nodes to be reflected more in the health assessment value of the assessment target node 20.

In step S346, the assessment value calculation unit 313 determines whether the integrated significance w′ has been obtained for all of the lower nodes.

If the integrated significance w′ has been obtained for all of the lower nodes, the processing proceeds to step S347.

In step S347, the assessment value calculation unit 313 performs processing to multiply the health assessment value H_{node_x} for each lower node by the integrated significance w′_{node_x}, to add the values resulting from the multiplications, and to set the value resulting from the addition as the health assessment value for the assessment target node 20. That is, the assessment value calculation unit 313 uses the integrated significance w′, which is the modified significance, to weight and add the health assessment value for the assessment target node 20.

The case of calculating the health assessment value Hp for the assessment target node 20 using the integrated significance w′, which is the modified significance, will be described. Assume that the assessment target node is dependent on the health of N lower nodes.

The health assessment value of each node on which the assessment target node 20 is dependent is represented as Hi (i=1, . . . , N), the integrated significance of each node on which it is dependent is represented as w′1 (i=1, . . . , N), and the total sum of the integrated significances w′ of all the lower nodes is represented as W. Then, the assessment value calculation unit 313 performs weighted addition as in Formula 1 below.

$$Health assessment value Hp = ( {w}^{′} 1 \cdot H 1 + … + {w}^{′} N \cdot HN ) / W \qquad ( Formula 1 )$$

Formula 1 allows any abnormality or deteriorated conditions of some nodes to be appropriately reflected in the health assessment values of higher nodes.

Variations of the specific examples are described.

### <Variation 1>

Assume that middle node 1 is dependent on nodes 1, 2, 3, 4 as shown in FIG. 5. The health assessment value Hp for middle node 1 is to be calculated.

th1=50 and th2=25.

α=5.

For node 1, H1=100 and w1=0.2.

For node 2, H2=70 and w2=0.3.

For node 3, H3=40 and w3=0.3.

For node 4, H4=20 and w4=0.2.

With the health assessment apparatus 300 according to the present embodiment, since H4=20 is smaller than th2=25, the health assessment value Hp for the middle node 1 is 20, which is the smallest among the lower nodes (step S349).

### <Variation 2>

Assume that middle node 1 is dependent on nodes 1, 2, 3, 4 as shown in FIG. 5. The health assessment value Hp for middle node 1 is to be calculated.

th1=50 and th2=25.

α=5.

For node 1, H1=100 and w1=0.2.

For node 2, H2=70 and w2=0.3.

For node 3, H3=40 and w3=0.3.

For node 4, H4=30 and w4=0.2.

With the health assessment apparatus 300 according to the present embodiment, there is no health assessment value that is equal to or smaller than th2.

H1=100 is greater than th1=50. Thus, w′1 is left unchanged at w1=0.2.

H2=70 is greater than th1=50. Thus, w′2 is left unchanged at w2=0.3.

H3=40 is greater than th2=25 and smaller than th1=50. Thus, w′3=α×w3=5×0.3=1.5.

H4=30 is greater than th2=25 and smaller than th1=50. Thus, w′4=α×w4=5×0.2=1.0.

The health assessment value Hp for middle node 1=(0.2×100+0.3×70+1.5×40+1.0×30)/(0.2+0.3+1.5+1.0)≈44.

### <Variation 3>

The health assessment values and significances of nodes 1, 2, 3, 4 are assumed to be similar to those for nodes 1, 2, 3, 4 in FIG. 6.

With the health assessment apparatus 300 according to the present embodiment, since H4=20 is smaller than th2=25, the health assessment value Hp for the middle node 1 is 20, which is the smallest among the lower nodes.

In the comparative example of FIG. 6, the health assessment value for middle node 1 is 60; information on node 4, which is in a hazardous condition, has been rounded by information integration.

In contrast, with the health assessment apparatus 300 according to the present embodiment, the health assessment value Hp for middle node 1 is calculated to be 20; information on node 4 is appropriately reflected in the health assessment value for middle node 1.

Referring back to FIG. 8, description is continued.

In step S305, the time limit estimation unit 333 calculates the operational time limit 32 of the assessment target node 20 based on the dependency information 33 and the operational time limits of the lower nodes. The composition assessment unit 303 stores the health assessment value 31 and the operational time limit 32 of the assessment target node 20 in the composition health database 334.

The operational time limits of the lower nodes include the operational time limits of the terminal nodes.

Specifically, the time limit estimation unit 333 extracts the worst value from the operational time limits of all the nodes on which the assessment target node 20 is dependent, and calculates the operational time limit 32 of the assessment target node 20 based on the worst value. The time limit estimation unit 333 extracts the operational time limit with a date closest to the point of assessment as the worst value.

In other words, the time limit estimation unit 333 takes the operational time limit that will arrive earliest among the operational time limits of the lower nodes of the assessment target node 20 as the operational time limit 32 of the assessment target node 20.

In step S306, the composition health estimation unit 331 stores the health assessment value 31 and the operational time limit 32 of the assessment target node 20 in the composition health database 334 as the health assessment information 34 for the assessment target node 20.

In step S307, the composition health estimation unit 331 checks whether health assessment on all the nodes in the vehicle composition including the vehicle composition itself (the vehicle composition, intermediate elements such as vehicles, and the nodes) is completed. If it is not completed, processing returns to step S302 to repeat processing; if it is completed, the processing ends.

In the specific example of FIG. 5, middle node 1 represents the assessment target node 20. In the processing described above, the nodes on which health assessment is completed at the point are referenced in each execution of step S302, and a node which is dependent on only any one of such nodes is taken as the next assessment target node, until finally health assessment on the “vehicle composition” is performed, upon which the processing is completed.

### <<Visualization Information Generation Process>>

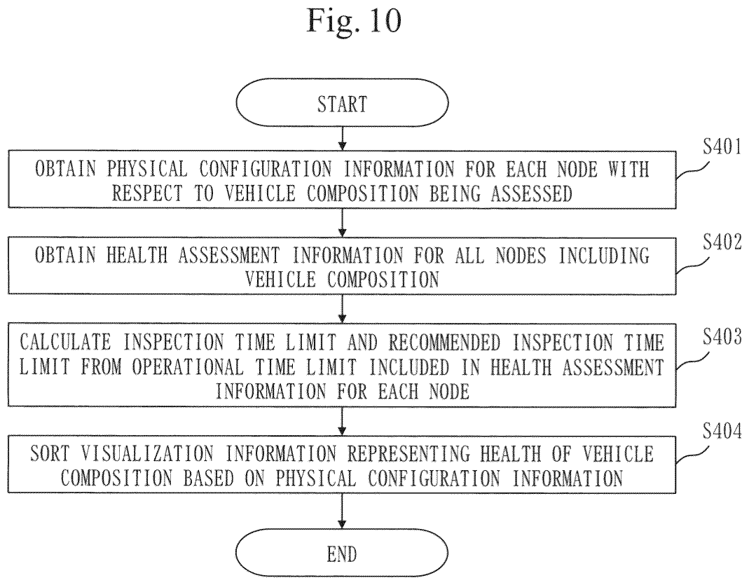

FIG. 10 is a flow diagram of a visualization information generation process by the visualization information generation unit 335 according to the present embodiment.

The visualization information generation process is executed at the visualization information generation unit 335. This processing represents a detailed flow of step S106 in the overall flow diagram of FIG. 4.

Upon completion of calculation of the health assessment value and the operational time limit for the vehicle composition, the visualization information generation unit 335 calculates inspection time limits representing the time limits of the respective inspections on the vehicle composition and the nodes based on the operational time limit of each node. The visualization information generation unit 335 then generates visualization information 35 for visualizing the respective health and inspection time limits of the vehicle composition and each node.

The visualization information generation unit 335 also calculates recommended inspection time limits by which start of the respective inspections on the vehicle composition and the nodes is recommended based on the respective inspection time limits of the vehicle composition and the nodes. The visualization information generation unit 335 then also includes information for visualizing the respective recommended inspection time limits for the vehicle composition and the nodes in the visualization information 35.

The visualization information generation unit 335 generates visualization information 35 for visualizing the respective health, the inspection time limits, and the recommended inspection time limits for the vehicle composition and the nodes as a temporal transition from the past to the present, and further in the future.

In step S401, the visualization information generation unit 335 obtains the physical configuration information for the vehicle composition stored in the physical configuration database 336.

In step S402, the visualization information generation unit 335 obtains the health assessment information for the vehicle composition and all the nodes constituting the vehicle composition stored in the composition health database 334.

In step S403, the visualization information generation unit 335 calculates information on the inspection time limit and information on the recommended inspection time limit of each node based on the operational time limits from the health assessment information.

Finally, in step S404, the visualization information generation unit 335 sorts the obtained health assessment information for all the nodes in accordance with the obtained physical configuration information.

Here, for the processing at step S403, the inspection time limit is a date subtracted from the operational time limit of the node of interest in consideration of the required number of days for its inspection. A recommended inspection time limit is a date subtracted from the inspection time limit in consideration of the number of days necessary for procurement of replacement parts related to maintenance of the node of interest and the minimum number of days necessary for allocation of maintenance staff (a lead time). Here, the required number of days for inspection and the lead time can be individually configured for the vehicle composition and each node constituting the vehicle composition, and can be set and changed by maintenance staff at the health monitoring apparatus 500.

After the flow of the visualization information generation process in FIG. 10 is completed, the visualization information generation unit 335 transmits the visualization information 35 for vehicle composition health to the health monitoring apparatus 500 in the processing at step S107.

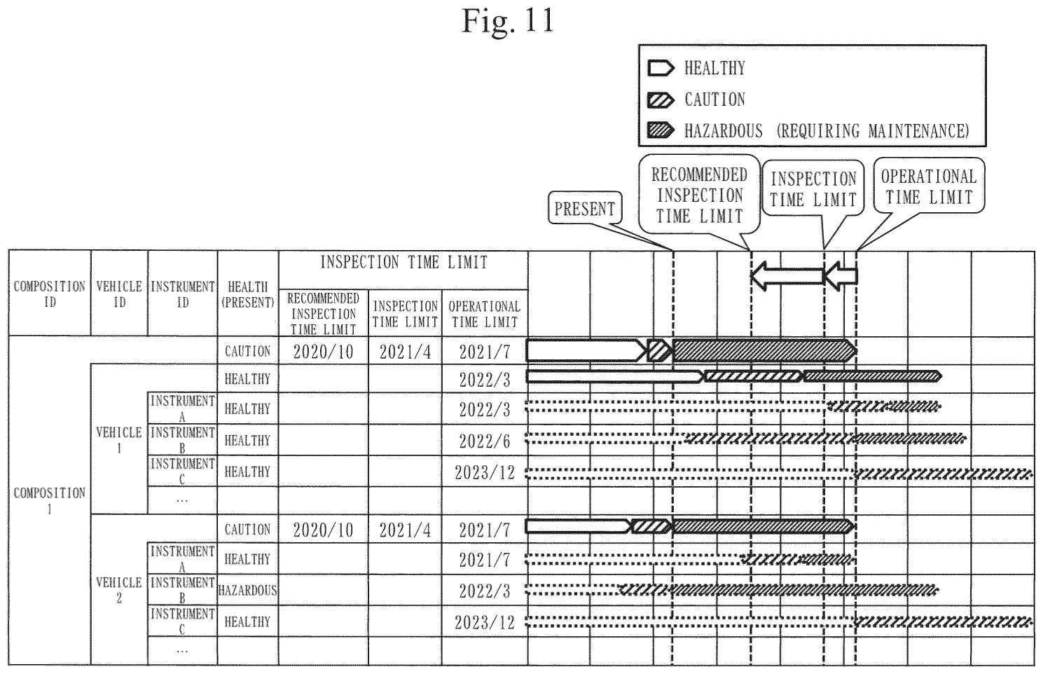

FIG. 11 illustrates an example of the visualization information 35 visualizing health assessment information according to the present embodiment.

FIG. 11 shows an exemplary presentation visualizing the respective health assessment information of the vehicle composition being assessed and the multiple nodes constituting the vehicle composition at the health monitoring apparatus 500.

In FIG. 11, the vehicle composition and the nodes are arranged in the order of sorting based on the physical configuration of the nodes in the vehicle composition by the processing in step S404. In the next column to the right, health assessment values at the point of assessment (the present) are set. Further on the right of it, pieces of information on the inspection time limits of instruments (recommended inspection time limit/inspection time limit/operational time limit) are set. Next to it, on the far right in the drawing, temporal transition of the health assessment values from the past to the present and further in the future is indicated.

The health assessment values may be indicated in the form of numerical values or may be converted to several types of label information, such as “healthy”, “caution”, and “hazardous” in FIG. 11, and indicated. Also, in the section on the temporal transition of the health assessment values, lines indicative of the present and the dates of the recommended inspection time limit/inspection time limit/operational time limit of the vehicle composition may be superimposed.

As shown in FIG. 11, with the health assessment system 700 according to the present embodiment, information on an instrument B of a vehicle 2 will not be rounded even when only the instrument B of the vehicle 2 is “hazardous”, which requires maintenance, and the other vehicles and instruments are in “healthy” condition. Information on the “hazardous” of the instrument B of the vehicle 2 is appropriately reflected in the “vehicle 2“and” composition 1”.

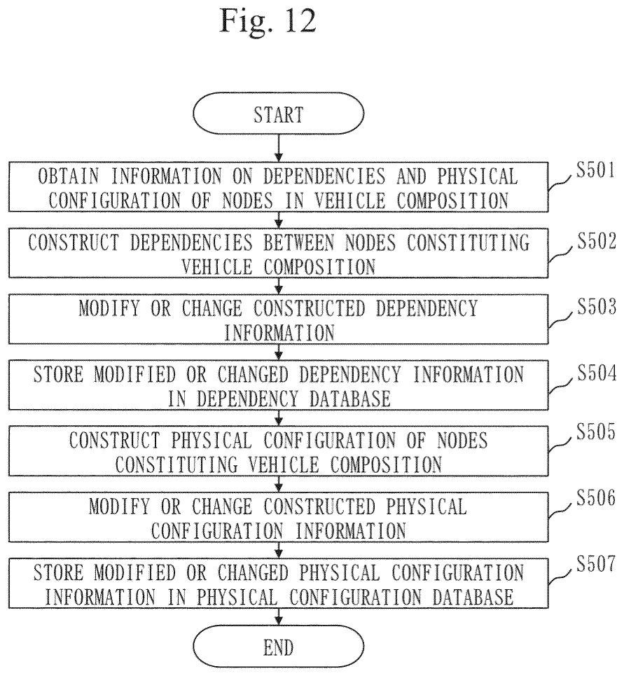

FIG. 12 is a flow diagram of processing to define the dependency database 332 and the physical configuration database 336 according to the present embodiment.

FIG. 12 shows a processing flow related to definition of instrument dependency information and instrument physical configuration information, which are necessary for vehicle composition health assessment.

The information setting unit 304 of the health assessment apparatus 300 obtains information on the dependencies and physical configuration of multiple nodes from the controller of the vehicle composition being assessed and stores it in a database.

The information setting unit 304 obtains information for modifying or changing the information on the dependencies and physical configuration of the multiple nodes and modifies or changes the database. Information for modifying or changing the information on the dependencies and physical configuration of the multiple nodes may also be obtained from a maintenance person via an input device of the health monitoring apparatus 500, for example.

In step S501, the vehicle data receiving unit 301 obtains information on the dependencies and physical configuration of the nodes constituting the vehicle composition from the controller included in the vehicle composition.

In step S502, the information setting unit 304 constructs the dependencies between the nodes constituting the vehicle composition as the dependency information 33.

In step S503, the information setting unit 304 modifies or changes the constructed dependency information 33 based on information obtained by the setting information receiving unit 306.

In step S504, the information setting unit 304 stores the modified or changed dependency information 33 in the dependency database 332.

In step S505, the information setting unit 304 constructs physical configuration for the nodes constituting the vehicle composition as the physical configuration information 36.

In step S506, the information setting unit 304 modifies or changes the constructed physical configuration information 36 based on information obtained by the setting information receiving unit 306.

In step S507, the information setting unit 304 stores the modified or changed physical configuration information 36 in the physical configuration database 336.

Here, regarding the processing in step S501, information on the dependencies and physical configuration of the nodes in the vehicle composition can be obtained from a controller that controls the entire vehicle composition, such as a train control and management system (TCMS), for example. TCMS is an abbreviation for Train Control and Management System.

Next, in relation to the processing in step S503 and step S506, the dependency information 33 or the physical configuration information 36 can be modified or changed at the information setting unit 503 of the health monitoring apparatus 500.

Information that can be modified or changed includes connections (directed graphs) in dependencies or physical configuration and the significance of dependencies between nodes. Modified or changed information can be also reviewed as needed while monitoring the temporal transition of health assessment, instead of being made once at the beginning as preparation for health assessment.

### Other Configurations

In the present embodiment, the functions of each apparatus of the health assessment system 700 are implemented in software. As a modification, the functions of each apparatus of the health assessment system 700 may be implemented in hardware.

Specifically, each apparatus of the health assessment system 700 includes an electronic circuit instead of the computation device.

An electronic circuit is a dedicated electronic circuit that implements the functions of each apparatus of the health assessment system 700. The electronic circuit specifically can be a single circuit, a composite circuit, a programmed processor, a parallel programmed processor, a logic IC, a GA, an ASIC, or an FPGA. GA is an abbreviation for Gate Array. ASIC is an abbreviation for Application Specific Integrated Circuit. FPGA is an abbreviation for Field-Programmable Gate Array.

The functions of each apparatus of the health assessment system 700 may be implemented by a single electronic circuit or implemented by being distributed among multiple electronic circuits.

As another modification, some of the functions of each apparatus of the health assessment system 700 may be implemented by an electronic circuit and the remaining functions may be implemented in software. Some or all of the functions of each apparatus of the health assessment system 700 may also be implemented in firmware.

Each of a processor and an electronic circuit is also called processing circuitry. That is, the functions of each apparatus of the health assessment system 700 are implemented by processing circuitry.

### Description of the Effects of the Present Embodiment

As has been described above, with the health assessment system 700 according to the present embodiment, the composition health estimation unit in the composition assessment unit which performs information integration on the lower nodes on which the assessment target node is dependent makes conditional case classification according to the health assessment value of each lower node and multiple thresholds. The composition health estimation unit in the composition assessment unit then dynamically applies an information integration logic suitable for each case to perform information integration process. The multiple thresholds can be the first threshold th1 and the second threshold th2 (th1>th2), for example.

In this way, the health assessment system 700 according to the present embodiment lessens the influence of information rounding, such that abnormality or deteriorated condition of some portions can be propagated to the overall health assessment value.

The health assessment system 700 according to the present embodiment also facilitates recognizing any abnormality and deteriorated condition of incorporated instruments from a health assessment value for the vehicle composition. As a health assessment value for a lower element of particularly high importance is more reliably propagated to upper elements, it has an effect of refining the health assessment on the whole (the vehicle composition).

### Embodiment 2

In the present embodiment, differences from Embodiment 1 and additions to Embodiment 1 will be primarily discussed.

In the present embodiment, components with similar functions to Embodiment 1 are given the same reference characters and description of them is omitted.

In Embodiment 1, an aspect that uses the first threshold th1 and the second threshold th2 as multiple thresholds in the integration process to integrate the health assessment values of lower nodes was described.

In the present embodiment, an aspect that further uses a third threshold th3, which is smaller than the first threshold th1 and greater than the second threshold th2, in addition to the first threshold th1 and the second threshold th2 as the multiple thresholds in the integration process to integrate the health assessment values of lower nodes will be described.

### Description of Configuration

The configuration of the health assessment system 700 according to the present embodiment is similar to that of Embodiment 1.

However, the threshold database 311 in FIG. 2 stores the third threshold th3 smaller than the first threshold th1 and greater than the second threshold th2, in addition to the first threshold th1 and the second threshold th2.

Furthermore, in the present embodiment, a first weighting factor α1 and a second weighting factor α2 are present as the weighting factor α. The second weighting factor α2 is assumed to be greater than the first weighting factor α1, that is, α2>α1.

In the present embodiment, the assessment value calculation unit 313 calculates the product of the corresponding significance w and the first weighting factor α1 as the integrated significance w′ for a lower node that has a health assessment value smaller than the first threshold th1 and equal to or greater than the third threshold th3. The assessment value calculation unit 313 calculates the product of the corresponding significance w and the second weighting factor α2 as the integrated significance w′ for a lower node that has a health assessment value smaller than the third threshold th3 and greater than the second threshold th2.

Since the second weighting factor α2 assumes a greater value than the first weighting factor α1, for a lower node with a smaller health assessment value, its health assessment value can be reflected more in the health assessment value for the assessment target node 20.

### Description of Operation

In the present embodiment, the flow diagram of processing to calculate the health assessment value for the assessment target node 20 in FIG. 9 described in Embodiment 1 is different from Embodiment 1.

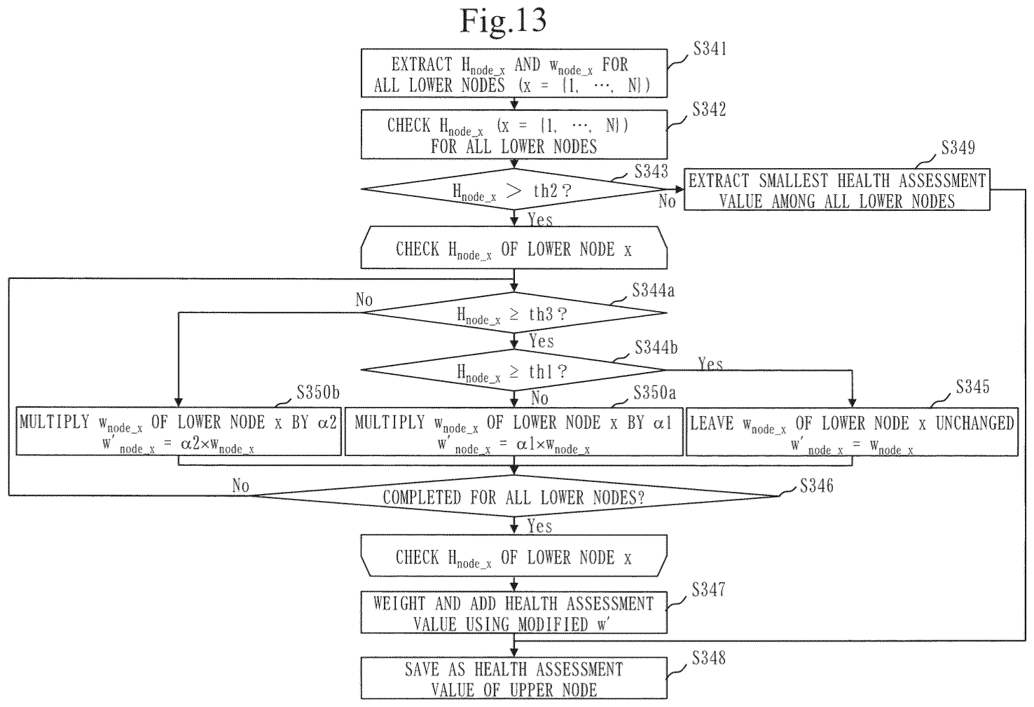

FIG. 13 is a flow diagram of processing to calculate a health assessment value for the assessment target node 20 according to the present embodiment. The flow diagram of FIG. 13 represents a detailed flow of step S304 in FIG. 8, described in Embodiment 1.

Processing in step S341 to step S343, step S346 to step S348, and step S349 is similar to FIG. 9, described in Embodiment 1.

As in Embodiment 1, processing in step S344a to step S346 is processing for a case where all of the health assessment values of the lower nodes are greater than the second threshold th2, that is, a case where there is no lower node that has a health assessment value equal to or smaller than the second threshold th2.

In the processing at step S344a to step S346, for each of all the lower nodes, the integrated significance w′ dependent on the relationship of magnitude between its health assessment value and the first threshold th1 and the third threshold th3 is calculated.

Then, in step S347, for each of all the lower nodes, its health assessment value is multiplied by the integrated significance w′ and the resulting values are added, thus calculating the health assessment value for the assessment target node 20.

Specifically, this is done in the following manner.

The assessment value calculation unit 313 performs processing for one lower node out of all the lower nodes as the multiple lower nodes of the assessment target node 20.

In step S344a, the assessment value calculation unit 313 determines whether the lower node undergoing processing has a health assessment value equal to or greater than the third threshold th3. That is, the assessment value calculation unit 313 determines whether H_{node_x}≥th3 or not for the health assessment value H_{node_x} of the lower node_x.

If the lower node has a health assessment value equal to or greater than the third threshold th3, the processing proceeds to step S344b.

If the lower node does not have a health assessment value equal to or greater than the third threshold th3, the processing proceeds to step S350b.

Being in step S350b means that the health assessment value of the lower node undergoing processing is smaller than the third threshold th3 and greater than the second threshold th2.

For a lower node that has a health assessment value smaller than the third threshold th3 and greater than the second threshold th2, the assessment value calculation unit 313 calculates the product of the corresponding significance w and the second weighting factor α2 as the integrated significance w′. That is, the assessment value calculation unit 313 multiples the corresponding significance w_{node_x} of the lower node_x by α2, that is, w′_{node_x}=α2×w_{node_x}.

In step S344b, the assessment value calculation unit 313 determines whether the lower node undergoing processing has a health assessment value equal to or greater than the first threshold th1. That is, the assessment value calculation unit 313 determines whether H_{node_x}>th1 or not for the health assessment value H_{node_x} of the lower node_x.

If the lower node has a health assessment value equal to or greater than the first threshold th1, the processing proceeds to step S345.

If the lower node does not have a health assessment value equal to or greater than the first threshold th1, the processing proceeds to step S350a.

In step S345, for a lower node that has a health assessment value equal to or greater than the first threshold th1, the assessment value calculation unit 313 obtains its corresponding significance w as the integrated significance w′ without modification. That is, the assessment value calculation unit 313 leaves the corresponding significance w_{node_x} of the lower node_x unchanged, w′_{node_x}=w_{node_x}.

Being in step S350a means that the health assessment value of the lower node undergoing processing is smaller than the first threshold th1 and equal to or greater than the third threshold th3.

In step S350a, for a lower node that has a health assessment value smaller than the first threshold th1 and equal to or greater than the third threshold th3, the assessment value calculation unit 313 calculates the product of the corresponding significance w and the first weighting factor α1 as the integrated significance w′. That is, the assessment value calculation unit 313 multiples the corresponding significance w_{node_x} of the lower node_x by al, that is, w′_{node_x}=α1×w_{node_x}.

Since the second weighting factor α2 assumes a greater value than the first weighting factor α1, for a lower node with a smaller health assessment value, such as having high level of degradation, its health assessment value can be reflected more in the health assessment value for the assessment target node 20.

This processing can increase significance for a lower node that has a relatively small health assessment value and reflect it more in the health assessment value of the assessment target node 20.

A specific variation is described.

### <Variation 4>

Assume that middle node 1 is dependent on nodes 1, 2, 3, 4. The health assessment value Hp for middle node 1 is to be calculated.

th1=75, th3=50, and th2=25.

α1=3 and α2=6.

For node 1, H1=100 and w1=0.2.

For node 2, H2=70 and w2=0.3.

For node 3, H3=40 and w3=0.3.

For node 4, H4=30 and w4=0.2.

With the health assessment apparatus 300 according to the present embodiment, there is no health assessment value that is equal to or smaller than th2.

H1=100 is greater than th1=75. Thus, w′1 is left unchanged at w1=0.2.

H2=70 is greater than th3=50 and smaller than th1=75. Thus, w′2 is w2=al x0.3=0.9.

H3=40 is greater than th2=25 and smaller than th3=50. Thus, w′3 is w3=α2×0.3=1.8.

H4=30 is greater than th2=25 and smaller than th3=50. Thus, w′4 is w4=α2×0.2=1.2.

The health assessment value Hp for the middle node 1=(0.2×100+0.9×70+1.8×40+1.2×30)/(0.2+0.9+1.8+1.2)≈46.6.

### Other Configurations

In Embodiment 1, two thresholds th1, th2 are used for dynamic determination of the integration process. In the present embodiment, three thresholds th1, th2, th3 are used for dynamic determination of the integration process. By employing the approaches of the embodiments described above, four or more thresholds may be used to execute dynamic determination of the integration process.

### Description of the Effects of the Present Embodiment

As has been described above, the health assessment system 700 according to the present embodiment can dynamically change the information integration logic in accordance with the health assessment values of a lower node to depend on by using three thresholds. Compared to determination of the information integration logic with two thresholds, a gap between health assessment values across a threshold can be made milder for the health assessment value of an upper node when there is a lower node around the threshold.

Hence, the health assessment system 700 according to the present embodiment can also provide the effect of more smoothly connecting between changes in assessment values around a threshold by increasing the number of thresholds (conditional case classifications), in addition to the effect of refining the calculation of the overall health assessment value due to the reduced effect of information rounding.

In Embodiments 1 and 2 above, the different units of each apparatus of the health assessment system were described as independent functional blocks. However, each apparatus of the health assessment system may not be in the configuration in the above-described embodiments. The functional blocks of each apparatus of the health assessment system can be in any configuration as long as they can realize the functions described in the embodiments above. Also, each apparatus of the health assessment system may be a system consisting of multiple devices rather than a single device.

Also, multiple portions from Embodiments 1 and 2 may be practiced in combination. Alternatively, a portion of these embodiments may be practiced. Furthermore, these embodiments may be practiced in any combination in their entirety or partially.

That is, for Embodiments 1 and 2, arbitrary combination of these embodiments, modification to certain components of the embodiments, or omission of certain components in the embodiments is possible.

The embodiments described above are essentially preferable illustrations, and are not intended to limit the scope of the present disclosure, the scope of an application of the present disclosure, and the scope of use of the present disclosure. The embodiments described above are amenable to various modifications as needed.

### REFERENCE SIGNS LIST

10: vehicle composition; 11: node; 20: assessment target node; 21: lower node; 31: health assessment value; 32: operational time limit; 33: dependency information; 34: health assessment information; 35: visualization information; 36: physical configuration information; 100: vehicle composition apparatus; 101: operation data collection unit; 102: operation data transmission unit; 200: vehicle visual inspection apparatus; 201: visual inspection unit; 202: inspection data transmission unit; 300: health assessment apparatus; 301: vehicle data receiving unit; 302: instrument assessment unit; 303: composition assessment unit; 304: information setting unit; 305: assessment information transmission unit; 306: setting information receiving unit; 311: threshold database; 312: determination unit; 313: assessment value calculation unit; 321: instrument health estimation unit; 322: instrument operational time limit estimation unit; 323: instrument health database; 331: composition health estimation unit; 332: dependency database; 333: time limit estimation unit; 334: composition health database; 335: visualization information generation unit; 336: physical configuration database; 400: schedule generation apparatus; 401: health assessment information receiving unit; 402: planning unit; 500: health monitoring apparatus; 501: visualization information receiving unit; 502: information visualization unit; 503: information setting unit; 504: setting information transmission unit; 700: health assessment system

1. A health assessment apparatus to assess health of a vehicle composition made up of a plurality of nodes, the health assessment apparatus comprising:
processing circuitry
to calculate a health assessment value representing health for a terminal node among the plurality of nodes, the terminal node being a node for which there is no lower node to depend on,
to obtain dependency information, in which dependencies between the plurality of nodes and significances representing strengths of the dependencies are set with the vehicle composition at top, from a dependency database that stores the dependency information, and for an assessment target node, among the plurality of nodes, that is being assessed and for which there are a plurality of lower nodes to depend on, to dynamically determine an integration process to integrate a health assessment value of the lower node in accordance with a relationship of magnitude between the health assessment value of the lower node and each of a plurality of thresholds, and to calculate a health assessment value of the assessment target node through the dynamically determined integration process,
to determine whether or not there is a lower node, among the plurality of lower nodes, that has a health assessment value equal to or smaller than a second threshold, the second threshold being smallest of the plurality of thresholds, and
to perform processing to, if there is no lower node that has a health assessment value equal to or smaller than the second threshold among the plurality of lower nodes, determine whether or not each one of the plurality of lower nodes has a health assessment value equal to or greater than a first threshold, the first threshold being greatest of the plurality of thresholds, and for a lower node that has a health assessment value smaller than the first threshold, as the integration process, to obtain the significance corresponding to said lower node from the dependency information as a corresponding significance and to calculate an integrated significance by multiplying the corresponding significance by a weighting factor which is defined in accordance with the relationship of magnitude between the health assessment value of said lower node and each of the plurality of thresholds, and for a lower node that has a health assessment value equal to or greater than the first threshold, to obtain the corresponding significance as the integrated significance, to multiply the health assessment value of each lower node by the integrated significance, to add values resulting from multiplications, and to set a value resulting from the addition as the health assessment value for the assessment target node.

2. The health assessment apparatus according to claim 1, wherein
the plurality of thresholds include a third threshold smaller than the first threshold and greater than the second threshold,
the weighting factor includes a first weighting factor and a second weighting factor, and
for a lower node that has a health assessment value smaller than the first threshold and equal to or greater than the third threshold, the processing circuitry calculates a product of the corresponding significance and the first weighting factor as the integrated significance, and for a lower node that has a health assessment value smaller than the third threshold and greater than the second threshold, the processing circuitry calculates a product of the corresponding significance and the second weighting factor as the integrated significance.

3. The health assessment apparatus according to claim 2, wherein
the second weighting factor is greater than the first weighting factor.

4. The health assessment apparatus according to claim 1, wherein
if there is a lower node having a health assessment value equal to or smaller than the second threshold among the plurality of lower nodes, the processing circuitry performs processing to set a smallest health assessment value of the respective health assessment values of the plurality of lower nodes to be the health assessment value for the assessment target node as the integration process.

5. The health assessment apparatus according to claim 2, wherein
if there is a lower node having a health assessment value equal to or smaller than the second threshold among the plurality of lower nodes, the processing circuitry performs processing to set a smallest health assessment value of the respective health assessment values of the plurality of lower nodes to be the health assessment value for the assessment target node as the integration process.

6. The health assessment apparatus according to claim 3, wherein
if there is a lower node having a health assessment value equal to or smaller than the second threshold among the plurality of lower nodes, the processing circuitry performs processing to set a smallest health assessment value of the respective health assessment values of the plurality of lower nodes to be the health assessment value for the assessment target node as the integration process.

7. The health assessment apparatus according to claim 1, wherein
the dependency database stores the dependency information in which the dependencies are defined by directed graphs and significances of the dependencies are associated with the directed graphs.

8. The health assessment apparatus according to claim 2, wherein
the dependency database stores the dependency information in which the dependencies are defined by directed graphs and significances of the dependencies are associated with the directed graphs.

9. The health assessment apparatus according to claim 3, wherein
the dependency database stores the dependency information in which the dependencies are defined by directed graphs and significances of the dependencies are associated with the directed graphs.

10. The health assessment apparatus according to claim 1, wherein
the processing circuitry takes a node for which there are nodes on which that node is dependent among the plurality of nodes as the assessment target node in sequence, and calculates the health assessment value for the assessment target node, and when calculation of health assessment values is completed for all the nodes on which the vehicle composition is dependent, calculates a health assessment value for the vehicle composition.

11. The health assessment apparatus according to claim 2, wherein
the processing circuitry takes a node for which there are nodes on which that node is dependent among the plurality of nodes as the assessment target node in sequence, and calculates the health assessment value for the assessment target node, and when calculation of health assessment values is completed for all the nodes on which the vehicle composition is dependent, calculates a health assessment value for the vehicle composition.

12. The health assessment apparatus according to claim 3, wherein
the processing circuitry takes a node for which there are nodes on which that node is dependent among the plurality of nodes as the assessment target node in sequence, and calculates the health assessment value for the assessment target node, and when calculation of health assessment values is completed for all the nodes on which the vehicle composition is dependent, calculates a health assessment value for the vehicle composition.

13. The health assessment apparatus according to claim 2, wherein
upon calculating a health assessment value and an operational time limit for the vehicle composition, the processing circuitry calculates inspection time limits representing time limits of respective inspections on the vehicle composition and each one of the plurality of nodes based on an operational time limit of each one of the plurality of nodes, and generates visualization information for visualizing the respective health and inspection time limits of the vehicle composition and each one of the plurality of nodes.

14. A health assessment method for use with a health assessment apparatus to assess health of a vehicle composition made up of a plurality of nodes, the health assessment method comprising:
calculating a health assessment value representing health for a terminal node among the plurality of nodes, the terminal node being a node for which there is no lower node to depend on; and
performing processing to obtain dependency information, in which dependencies between the plurality of nodes and significances representing strengths of the dependencies are set with the vehicle composition at top, from a dependency database that stores the dependency information, and for an assessment target node, among the plurality of nodes, that is being assessed and for which there are a plurality of lower nodes to depend on, to dynamically determine an integration process to integrate a health assessment value of the lower node in accordance with a relationship of magnitude between the health assessment value of the lower node and each of a plurality of thresholds, and to calculate a health assessment value of the assessment target node through the dynamically determined integration process, wherein it is determined whether or not there is a lower node, among the plurality of lower nodes, that has a health assessment value equal to or smaller than a second threshold, the second threshold being smallest of the plurality of thresholds, and if there is no lower node that has a health assessment value equal to or smaller than the second threshold among the plurality of lower nodes, it is determined whether or not each one of the plurality of lower nodes has a health assessment value equal to or greater than a first threshold, the first threshold being greatest of the plurality of thresholds, and for a lower node that has a health assessment value smaller than the first threshold, as the integration process, the significance corresponding to said lower node is obtained from the dependency information as a corresponding significance and an integrated significance is calculated by multiplying the corresponding significance by a weighting factor which is defined in accordance with the relationship of magnitude between the health assessment value of said lower node and each of the plurality of thresholds, and for a lower node that has a health assessment value equal to or greater than the first threshold, the corresponding significance is obtained as the integrated significance, the health assessment value of each lower node is multiplied by the integrated significance, values resulting from multiplications are added, and a value resulting from the addition is set as the health assessment value for the assessment target node.

15. A non-transitory computer readable medium storing a health assessment program for use with a health assessment apparatus to assess health of a vehicle composition made up of a plurality of nodes, the health assessment program causing a computer to execute:
an instrument assessment process to calculate a health assessment value representing health for a terminal node among the plurality of nodes, the terminal node being a node for which there is no lower node to depend on; and
a composition assessment process to obtain dependency information, in which dependencies between the plurality of nodes and significances representing strengths of the dependencies are set with the vehicle composition at top, from a dependency database that stores the dependency information, and for an assessment target node, among the plurality of nodes, that is being assessed and for which there are a plurality of lower nodes to depend on, to dynamically determine an integration process to integrate a health assessment value of the lower node in accordance with a relationship of magnitude between the health assessment value of the lower node and each of a plurality of thresholds, and to calculate a health assessment value of the assessment target node through the dynamically determined integration process, wherein
the composition assessment process includes
a determination process to determine whether or not there is a lower node, among the plurality of lower nodes, that has a health assessment value equal to or smaller than a second threshold, the second threshold being smallest of the plurality of thresholds, and
an assessment value calculation process to perform processing to, if there is no lower node that has a health assessment value equal to or smaller than the second threshold among the plurality of lower nodes, determine whether or not each one of the plurality of lower nodes has a health assessment value equal to or greater than a first threshold, the first threshold being greatest of the plurality of thresholds, and for a lower node that has a health assessment value smaller than the first threshold, as the integration process, to obtain the significance corresponding to said lower node from the dependency information as a corresponding significance and to calculate an integrated significance by multiplying the corresponding significance by a weighting factor which is defined in accordance with the relationship of magnitude between the health assessment value of said lower node and each of the plurality of thresholds, and for a lower node that has a health assessment value equal to or greater than the first threshold, to obtain the corresponding significance as the integrated significance, to multiply the health assessment value of each lower node by the integrated significance, to add values resulting from multiplications, and to set a value resulting from the addition as the health assessment value for the assessment target node.
